(19) United States
(12) Patent Application Publication
(10) Pub. No.: US 2017/0203812 A1
(43) Pub. Date: Jul. 20, 2017

(54) Remote Bicycle Stopping Device

(71) Applicant: Carl Puntarich, Mount Siani, NY (US)

(72) Inventor: Carl Puntarich, Mount Siani, NY (US)

(21) Appl. No.: 14/997,633

(22) Filed: Jan. 18, 2016

(51) Int. Cl. B62L 3/00; B62J 99/00; B62L 1/12

(52) U.S. Cl. CPC B62L 3/00; B62L 1/12; B62J 99/00; B62J 2099/0013

(57) ABSTRACT

A remote bicycle stopping device for remote stopping of a bicycle includes a bicycle brake that is operationally coupled to a bicycle. A GPS-enabled control unit capable of sending and receiving wireless signals is coupled to the bicycle. An effector unit is positioned on and operationally coupled to the bicycle brake. The effector unit is wirelessly coupled to the control unit. The device includes a GPS-enabled transmitting unit that is capable of sending and receiving wireless signals. The transmitting unit sends wirelessly a separation limit defined by the user to the control unit. The separation limit is evaluated as a distance between the GPS coordinates of the transmitting unit and the control unit. Should the separation limit be exceeded, the control unit will send a wireless signal to the effector unit, causing the effector unit to engage the bicycle brake to bring the bicycle to a stop.

### BACKGROUND OF THE DISCLOSURE

### Field of the Disclosure The disclosure relates to bicycle stopping devices and more particularly pertains to a new bicycle stopping device for remote stopping of a bicycle.

### SUMMARY OF THE DISCLOSURE

An embodiment of the disclosure meets the needs presented above by generally comprising a bicycle brake that is operationally coupled to a bicycle. A GPS-enabled control unit capable of sending and receiving wireless signals is coupled to the bicycle. An effector unit is positioned on and operationally coupled to the bicycle brake. The effector unit is wirelessly coupled to the control unit. The device includes a GPS-enabled transmitting unit that is capable of sending and receiving wireless signals. The transmitting unit sends wirelessly a separation limit defined by the user to the control unit. The separation limit is evaluated as a distance between the GPS coordinates of the transmitting unit and the control unit. Should the separation limit be exceeded, the control unit will send a wireless signal to the effector unit, causing the effector unit to engage the bicycle brake to bring the bicycle to a stop.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a remote bicycle stopping device according to an embodiment of the disclosure.

FIG. 2 is a front view of an embodiment of the disclosure.

FIG. 3 is a front view of an embodiment of the disclosure.

FIG. 4 is an in-use view of an embodiment of the disclosure.

FIG. 5 is a block diagram of an embodiment of the disclosure.

### DESCRIPTION OF THE PREFERRED EMBODIMENT

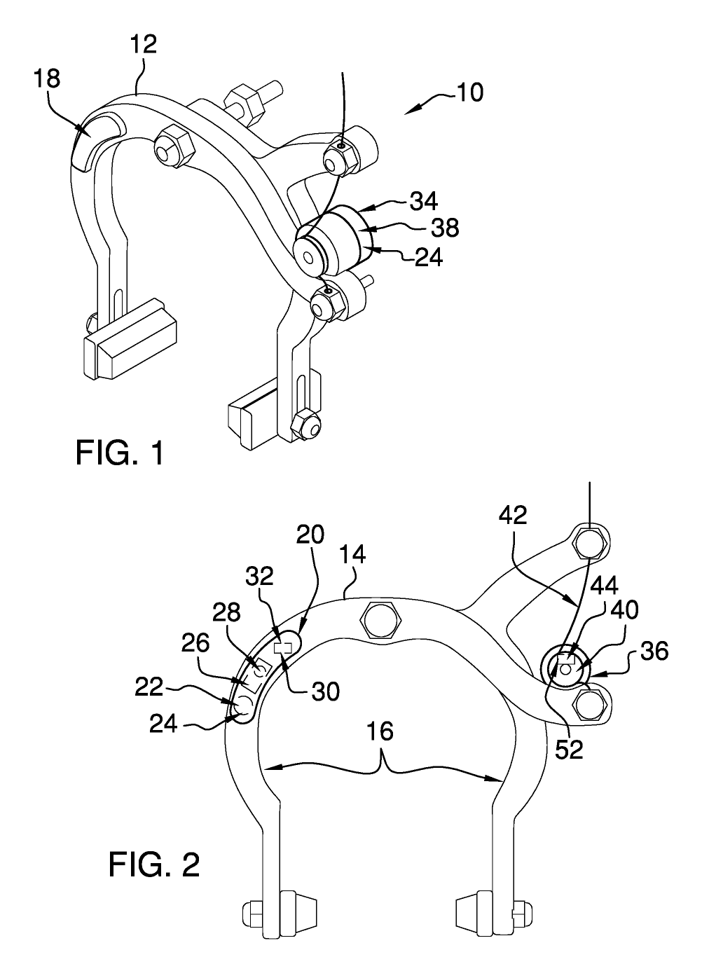

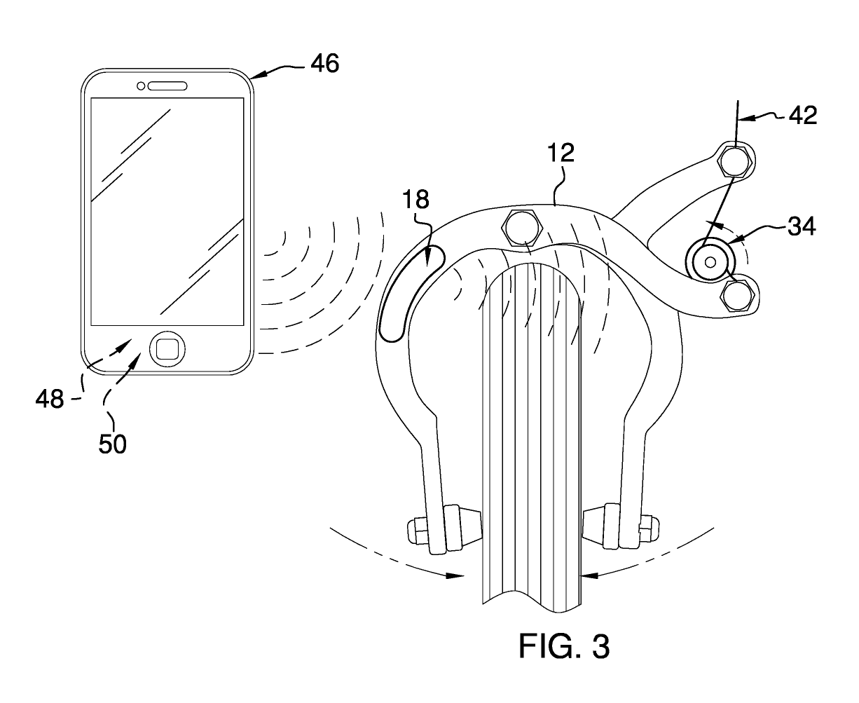

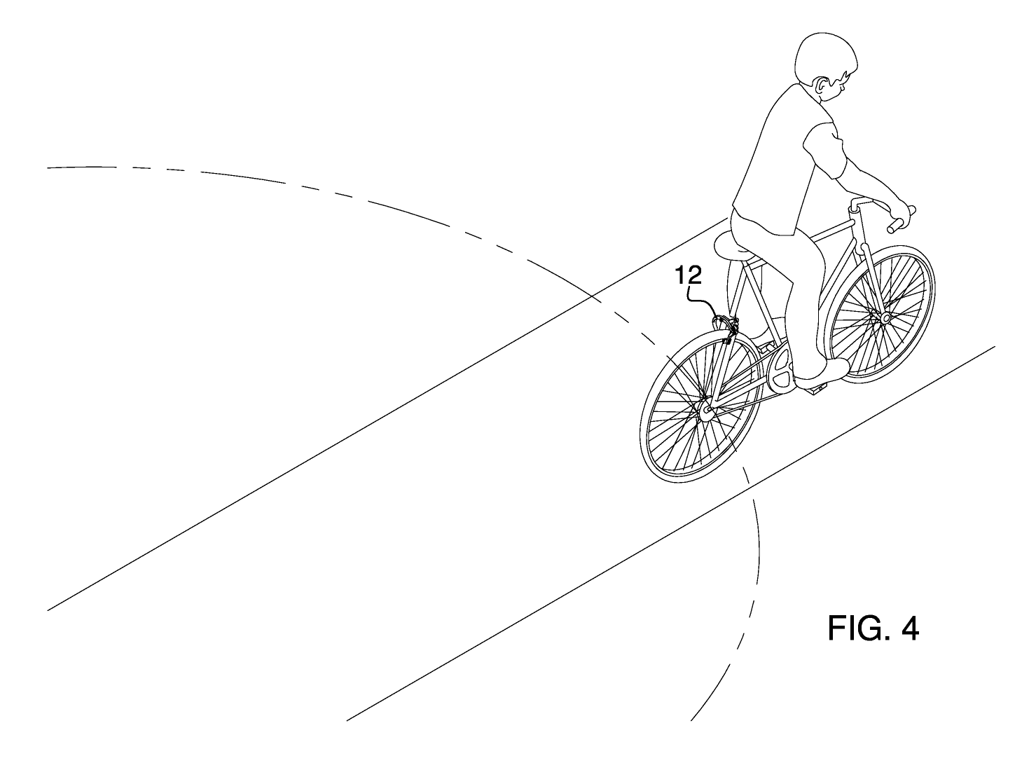

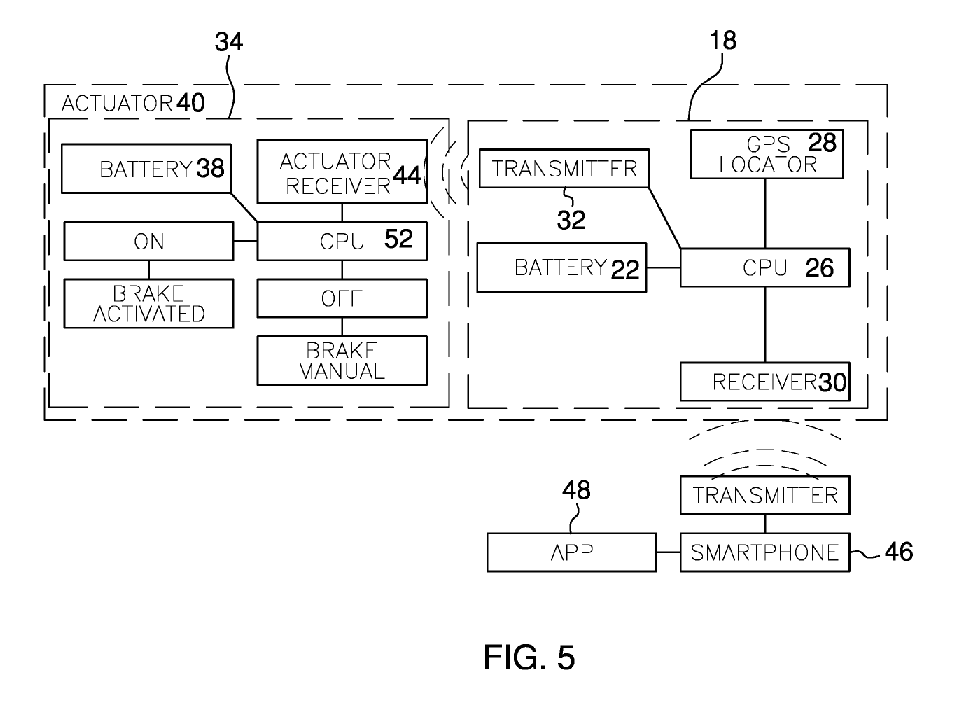

With reference now to the drawings, and in particular to FIGS. 1 through 5 thereof, a new bicycle stopping device embodying the principles and concepts of an embodiment of the disclosure and generally designated by the reference numeral 10 will be described.

As best illustrated in FIGS. 1 through 5, the remote bicycle stopping device 10 generally comprises a bicycle brake 12, preferably a caliper brake 14 comprising a pair of arms 16. Preferably, the caliper brake 14 is cantilevered.

A control 18 unit is coupled to a bicycle. The control unit 18 is capable of sending and receiving wireless signals. The control unit 18 is GPS-enabled. More specifically, the control unit 18 comprises a housing 20 that is coupled to and positioned on a bicycle. Preferably, the housing 20 is coupled to and positioned on the bicycle brake 12. Alternatively, the housing 20 is coupled to and positioned in a respective one of the pair of arms 16, such that the housing 20 is integral to the respective one of the pair of arms 16. A power module 22 is coupled to and positioned in the housing 20. The power module 22 comprises at least one battery 24. A first processor 26 is coupled to and positioned in the housing 20. The first processor 26 is operationally coupled to the power module 22. A GPS receiver 28 is coupled to and positioned in the housing 20. The GPS receiver 28 is operationally coupled to the first processor 26 and the power module 22. A first receiver 30 is coupled to and positioned in the housing 20. The first receiver is 30 operationally coupled to the first processor 26 and the power module 22, such that the first receiver 26 is capable of receiving wireless signals from the user. The first receiver 26 is Bluetooth enabled. A transmitter 32 is coupled to and positioned in the housing 20. The transmitter 32 is operationally coupled to the first processor 26 and the power module 22. The transmitter 32 also is Bluetooth enabled.

An effector unit 34 is positioned on and operationally coupled to the bicycle brake 12. The effector unit 34 is operationally coupled to the control unit 18. Preferably, the effector unit 34 is wirelessly coupled to the control unit 18. More specifically, the effector unit 34 comprises a casing 36 that is coupled to and positioned on the bicycle brake 12. Preferably, the casing 36 is positioned on a respective one of the pair of arms 16. A power unit 38 is coupled to and positioned in the casing 36. The power unit 38 comprises at least one battery 24. An actuator 40 is coupled to and positioned in the casing 36. The actuator 40 is operationally coupled to the bicycle brake 12 and the power unit 38. Preferably, the actuator 40 is operationally coupled to a cable 42 of the caliper brake 14. A second processor 52 is coupled to and positioned in the casing 36. The second processor 52 is operationally coupled to the power unit 38 and the actuator 40. A second receiver 44 is coupled to and positioned in the casing 36. The second receiver 44 is operationally coupled to the second processor 52 and the power unit 38. The second receiver 52 also is Bluetooth enabled and capable of receiving wireless signals produced by said transmitter 32.

The device 10 also includes a transmitting unit 46 that is capable of sending and receiving wireless signals. The transmitting unit 46 is GPS-enabled and comprises a computer program 48. The program 48 is installable on the user's GPS-enabled electronic devices. The program 48 includes programmable software controls 50, wherein the program 48 can be configured by the user to define a separation limit between the control unit 18 and the transmitting unit 46. The separation limit is evaluated by the first processor 26 as a distance between the GPS coordinates of the transmitting unit 46 and the control unit 18. Should the separation limit be exceeded, the first processor 26 will send a signal via the transmitter 32 and the second receiver 44 to the second processor 52, wherein the actuator 40 will be compelled to engage the bicycle brake 12. The computer program 48 also has manual override capability, such that the user may engage the bicycle brake 12 without the separation limit being exceeded.

In use, the transmitting unit 46 sends wirelessly a separation limit defined by the user to the control unit 18, and such that the control unit 18 will send a wireless signal to the effector unit 34 should the separation limit be exceeded, wherein the effector unit 34 will engage the bicycle brake 12, bringing the bicycle to a stop.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A remote bicycle stopping device comprising:
a bicycle brake, said bicycle brake being operationally coupled to a bicycle;
a control unit, said control unit being coupled to the bicycle, said control unit being capable of sending and receiving wireless signals, said control unit being GPS-enabled;
an effector unit, said effector unit being positioned on and operationally coupled to said bicycle brake, said effector unit being wirelessly coupled to said control unit;
a transmitting unit, said transmitting unit being capable of sending and receiving wireless signals, said transmitting unit being GPS-enabled; and
wherein said transmitting unit sends wirelessly a separation limit defined by the user to said control unit, and such that said control unit will send a wireless signal to said effector unit should the separation limit be exceeded, wherein said effector unit will engage said bicycle brake, bringing the bicycle to a stop.

2. The device of claim 1, further including said bicycle brake being a caliper brake, said caliper brake comprising a pair of arms.

3. The device of claim 2, further including said caliper brake being cantilevered.

4. The device of claim 2, further including said control unit comprising:
a housing, said housing being coupled to and positioned on a bicycle;
a power module, said power module being coupled to and positioned in said housing;
a first processor, said first processor being coupled to and positioned in said housing, said first processor being operationally coupled to said power module;
a GPS receiver, said GPS receiver being coupled to and positioned in said housing, said GPS receiver being operationally coupled to said first processor and said power module;
a first receiver, said first receiver being coupled to and positioned in said housing, said first receiver being operationally coupled to said first processor and said power module, such that said first receiver is capable of receiving wireless signals from the user; and
a transmitter, said transmitter being coupled to and positioned in said housing, said transmitter being operationally coupled to said first processor and said power module.

5. The device of claim 4, further including said housing being coupled to and positioned on said bicycle brake.

6. The device of claim 4, further comprising:
said bicycle brake being a caliper brake, said caliper brake comprising a pair of arms; and
said housing being coupled to and positioned in a respective one of said pair of arms, such that said housing is integral to said respective one of said pair of arms.

7. The device of claim 4, further including said power module comprising at least one battery.

8. The device of claim 4, further including said first receiver and said transmitter being Bluetooth enabled.

9. The device of claim 1, further including said effector unit comprising:
a casing, said casing being coupled to and positioned on said bicycle brake;
a power unit, said power unit being coupled to and positioned in said casing;
an actuator, said actuator being coupled to and positioned in said casing, said actuator being operationally coupled to said bicycle brake and said power unit;
a second processor, said second processor being coupled to and positioned in said casing, said second processor being operationally coupled to said power unit and said actuator; and
a second receiver, said second receiver being coupled to and positioned in said casing, said second receiver being operationally coupled to said second processor and said power unit.

10. The device of claim 9, further comprising:
said bicycle brake being a caliper brake, said caliper brake comprising a pair of arms; and
said casing being positioned on a respective one of said pair of arms.

11. The device of claim 10, further including said actuator being operationally coupled to a cable of said caliper brake.

12. The device of claim 9, further including said power unit comprising at least one battery.

13. The device of claim 9, further including said second receiver being Bluetooth enabled.

14. The device of claim 1, further including said transmitting unit comprising a computer program, said program being installable on the user's GPS-enabled electronic devices, said program including programmable software controls, wherein said program can be configured by the user to define a separation limit between said control unit and said transmitting unit.

15. The device of claim 14, further including said computer program having manual override capability, such that the user may engage said bicycle brake without the separation limit being exceeded.

16. A remote bicycle stopping device comprising:
a bicycle brake, said bicycle brake being a caliper brake, said caliper brake comprising a pair of arms, said caliper brake being cantilevered;
a control unit, said control unit being coupled to a bicycle, said control unit being capable of sending and receiving wireless signals, said control unit being GPS-enabled;
said control unit comprising:
a housing, said housing being coupled to and positioned on a bicycle, said housing being coupled to and positioned on said bicycle brake, said housing being coupled to and positioned in a respective one of said pair of arms, such that said housing is integral to said respective one of said pair of arms;
a power module, said power module being coupled to and positioned in said housing, said power module comprising at least one battery;
a first processor, said first processor being coupled to and positioned in said housing, said first processor being operationally coupled to said power module;
a GPS receiver, said GPS receiver being coupled to and positioned in said housing, said GPS receiver being operationally coupled to said first processor and said power module;
a first receiver, said first receiver being coupled to and positioned in said housing, said first receiver being operationally coupled to said first processor and said power module, such that said first receiver is capable of receiving wireless signals from the user, said first receiver being Bluetooth enabled;
a transmitter, said transmitter being coupled to and positioned in said housing, said transmitter being operationally coupled to said first processor and said power module, said transmitter being Bluetooth enabled;
an effector unit, said effector unit being positioned on and operationally coupled to said bicycle brake, said effector unit being wirelessly coupled to said control unit;
said effector unit comprising:
a casing, said casing being coupled to and positioned on said bicycle brake, said casing being positioned on a respective one of said pair of arms;
a power unit, said power unit being coupled to and positioned in said casing, said power unit comprising at least one battery;
an actuator, said actuator being coupled to and positioned in said casing, said actuator being operationally coupled to said bicycle brake and said power unit, said actuator being operationally coupled to a cable of said caliper brake;
a second processor, said second processor being coupled to and positioned in said casing, said second processor being operationally coupled to said power unit and said actuator;
a second receiver, said second receiver being coupled to and positioned in said casing, said second receiver being operationally coupled to said second processor and said power unit, said second receiver being Bluetooth enabled;
a transmitting unit, said transmitting unit being capable of sending and receiving wireless signals, said transmitting unit being GPS-enabled;
said transmitting unit comprising a computer program, said program being installable on the user's GPS-enabled electronic devices, said program including programmable software controls, wherein said program can be configured by the user to define a separation limit between said control unit and said transmitting unit, wherein said separation limit is evaluated by said first processor as a distance between the GPS coordinates of said transmitting unit and said control unit, and such that, in the event the separation limit is exceeded, said first processor will send a signal via said transmitter and said second receiver to said second processor, wherein said actuator will be compelled to engage said bicycle brake, said computer program having manual override capability, such that the user may engage said bicycle brake without the separation limit being exceeded; and
wherein said transmitting unit sends wirelessly a separation limit defined by the user to said control unit, and such that said control unit will send a wireless signal to said effector unit should the separation limit be exceeded, wherein said effector unit will engage said bicycle brake, bringing the bicycle to a stop.
